(19) United States
(12) Patent Application Publication
(10) Pub. No.: US 2022/0104655 A1
(43) Pub. Date: Apr. 7, 2022

(54) Waffle Maker

(71) Applicant: TRISTAR PRODUCTS, INC., Fairfield, NJ (US)

(72) Inventors: James MITRIK, Fairfield, NJ (US); Paul MCGRATH, Fairfield, NJ (US)

(73) Assignee: TRISTAR PRODUCTS, INC., Fairfield, NJ (US)

(21) Appl. No.: 17/333,526

(22) Filed: May 28, 2021

Related U.S. Application Data
(62) Division of application No. 17/063,830, filed on Oct. 6, 2020, now abandoned.

(51) Int. Cl. A47J 37/06; A21B 3/13; A21D 13/40

(52) U.S. Cl. CPC A47J 37/0611; A21D 13/40; A21B 3/131

(57) ABSTRACT

The present technology provides a device, such as a waffle form, that uses an alternative heat source to cook a waffle instead of an internal heating element or a direct flame. The waffle form includes upper and lower elements to allow the waffle maker to be closed to create a sealed interior cooking environment and then placed in a chamber to allow circulated heated air to heat the surface of the waffle maker. The upper element may have configurable shapes, such as concave or convex, to create waffles of different shapes or to allow stuffing ingredients to be baked into the waffle. The waffle maker may use connections and a fastening mechanism to allow the waffle maker to be suspended from rotisserie connections in a multi-purpose cooker, such as an air fryer, rotated around an axis, and removed after the waffle is fully cooked.

### FIELD OF INVENTION

The present invention relates to cooking devices. In even greater particularity, the present invention relates to a cooking device for cooking waffles and stuffed waffles.

### BACKGROUND

Conventional waffle makers typically are made of iron or another similar metal. Batter is poured into a lower element of the waffle maker and then the upper element is closed to encase the batter. The conventional waffle maker typically has a pattern, such as a honeycomb pattern, cast into the cooking surface of the two elements to imprint the pattern onto the surface of the waffle.

The waffle maker is typically heated by an internal heating element controlled by a temperature controller. Other waffle makers are heated by an external heating source, such as by holding the waffle maker over a flame.

### SUMMARY OF THE INVENTION

The present technology provides a device, such as a waffle form, that uses an alternative heat source to cook the waffle instead of an internal heating element or a direct flame. The waffle form includes connections to allow the waffle maker to be closed to create a sealed interior cooking environment and then placed in a chamber to allow circulated heated air to heat the surface of the waffle maker. The waffle form includes upper and lower elements to create the sealed interior cooking environment. The upper element may be configured to create larger or smaller cooking environments. The upper element may have configurable shapes, such as concave or convex, to create waffles of different shapes or to allow stuffing ingredients to be baked into the waffle. In an example, the waffle maker may use connections and a fastening mechanism to allow the waffle maker to be suspended from rotisserie connections in an air fryer, rotated around an axis, and removed after the waffle is fully cooked.

These and other aspects, objects, features, and advantages of the example embodiments will become apparent to those having ordinary skill in the art upon consideration of the following detailed description of illustrated example embodiments.

### BRIEF DESCRIPTION OF THE DRAWINGS

The drawings are appended hereto and form a portion of this disclosure.

FIG. 1 is a perspective view of one embodiment of a multi-purpose cooker, in accordance with certain examples of the technology disclosed herein.

FIG. 2 is a block diagram depicting a method to cook a waffle on a shelf in a multi-purpose cooker, in accordance with certain examples of the technology disclosed herein.

FIG. 3 is a block diagram depicting a method to cook a waffle on a rotisserie in a multi-purpose cooker, in accordance with certain examples of the technology disclosed herein.

FIG. 4 is a block diagram depicting a method to cook a stuffed waffle in a multi-purpose cooker, in accordance with certain examples of the technology disclosed herein.

FIG. 5 is a block diagram depicting a method to cook food in a multi-function cooker, in accordance with certain examples of the technology disclosed herein.

FIG. 6 is a cross sectional perspective view of one embodiment of a closed waffle form.

FIG. 7 is a perspective view of one embodiment of an open waffle form.

FIG. 8 is a side view of one embodiment of a multi-purpose cooker with a waffle form on a shelf.

FIG. 9 is a perspective view of one embodiment of a closed waffle form with rotisserie spikes and a stand.

FIG. 10 is a perspective view of one embodiment of an open waffle form with rotisserie spikes and a stand.

FIG. 11 is a perspective view of one embodiment of a multi-purpose cooker with a waffle form affixed to a rotisserie mechanism.

### DETAILED DESCRIPTION

The example embodiments described herein provide method to cook a waffle. The examples describe a method to cook a waffle on a shelf in an air fryer or cook a waffle on a rotisserie attachment in a multi-function cooker, such as an air fryer. The method utilizes a waffle form that is formed of a substantially uniform thickness and receives cooking heat from the heated circulated air of an air fryer. The heated air is conducted through the body of the waffle form and to the ingredients inside the waffle form.

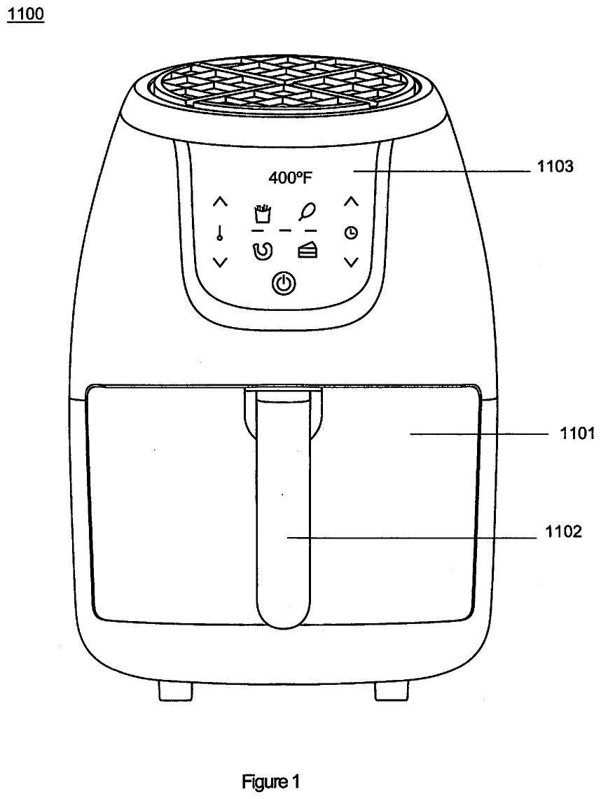

FIG. 1 is a perspective view of one embodiment of a multi-purpose cooker 1100, in accordance with certain examples of the technology disclosed herein. The multi-purpose cooker 1100 is configurable to cook a waffle, bake, grill, steam, and air fry food goods. The multi-purpose cooker 1100 is depicted with a door 1101 with a handle 1102. The door 1101 may be used to place food and cooking components inside a cooking chamber of the multi-purpose cooker 1100 and/or to remove the food and components. A display 1103 is illustrated with features such as temperature display, timer settings, temperature settings, quick start functions, preset cooking processes, or any other suitable controls. The controls may be buttons, toggles, switches, or other physical interface objects. The controls may be digital representations of interface objects. For example, the display 1103 may be a touchscreen.

The multi-purpose cooker 1100 is suitable to cook various foods in different configurations, including air frying. The multi-purpose cooker 1100 utilizes one or more of a set of components to cook the waffle. The component to cook the waffle may be the waffle form 500 as described herein. The component to cook waffles may also be utilized as described herein to cook a stuffed waffle or other baked stuffed good. The multi-purpose cooker 1100 includes other components that are configured to grill, air fry, steam, and bake food products. The multi-purpose cooker 1100 may use a grill component, such as a plate with or without raised grilled cross hatching, that is heated to grill meat, vegetables, or other food products. The plate is heated in the chamber via the heated circulated air. Another component may be a wire basket or wire bowl for air frying food products. Another component of the multi-purpose cooker 1100 provides steam to a container inside the chamber to steam food products.

The multi-purpose cooker 1100 may have similar features as multi-purpose cooker 700 described herein, such as a shelf or rotisserie mechanisms.

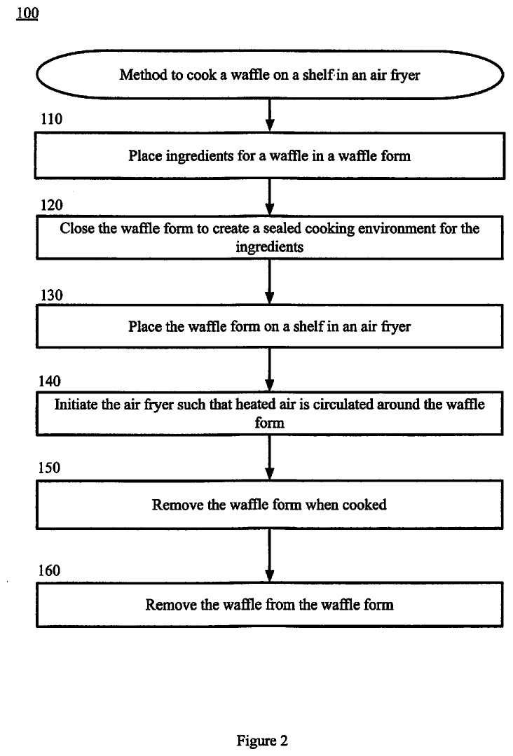

FIG. 2 is a block diagram depicting a method 100 to cook a waffle on a shelf in a multi-purpose cooker, such as an air fryer, in accordance with certain examples of the technology disclosed herein.

In block 110, a user places the ingredients for a waffle in waffle form 500. The ingredients may be for any style or type of waffle or other baked goods. The ingredients may include stuffing food items to create a stuffed waffle as described herein.

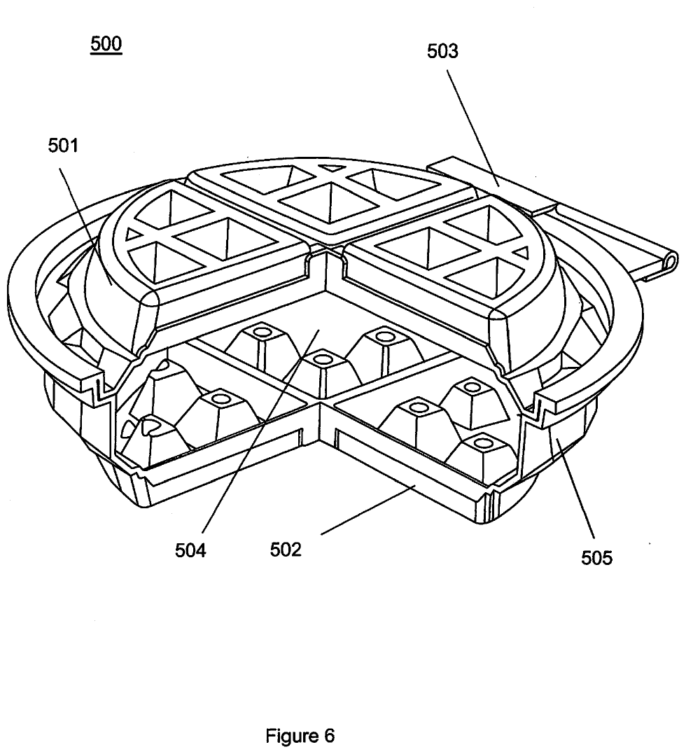

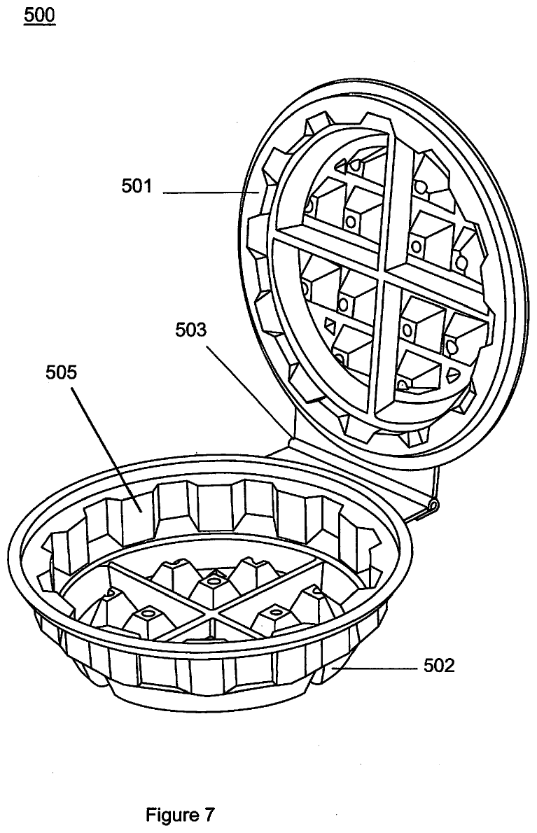

The waffle form is described in greater detail in FIG. 6 and FIG. 7.

FIG. 6 is a cross sectional perspective view of one embodiment of a closed waffle form 500. As depicted, the waffle form 500 has an upper element 501 and a lower element 502. The upper element 501 and the lower element 502 are formed of a heat conductive metal or other material, such as aluminum, iron, or a composite material. The metal may be coated with a material to make the metal smoother or less porous, or to achieve any other desired finish, such as to make the metal safe for a dishwasher or to be non-stick.

The upper element 501 and the lower element 502 may be connected by a hinge 503 or any other type of connection. The hinge 503 allows the waffle form 500 to open or close in a clamshell type of motion. When the hinge 503 is in a closed position such that upper element 501 and lower element 502 are in contact, as depicted in FIG. 6, an enclosed space is created between the upper element 501 and the lower element 502. The enclosed space is a cooking environment 504 for any desired ingredients.

The waffle form 500 may have sidewalls 505 between the upper element 501 and the lower element 502. The sidewalls 505 may be part of the lower element 502 in a single unit comprising the lower element 502 and the sidewalls 505.

In certain examples, the upper element 501 may be shaped or configured to create different sized and shaped waffles. For example, the upper element 501 may be of a pronounced convex shape that creates a larger cooking environment 504. The larger cooking environment allows the waffle form 500 to encase stuffing ingredients inside the waffle to create a stuffed waffle. For example, food items such as bacon, sausage, fruit, pie filling, pizza toppings, cream cheese, or any other suitable stuffing, are placed into the waffle form with waffle batter. When the waffle is cooked, the stuffing ingredients are cooked into waffle as a stuffing. In another example, the upper element 501 is a concave shape and creates a bowl-shaped cooking environment 504 for cooking a bowl-shaped waffle. In another example, the lower element 502 is also bowl shaped, such that the bowl-shaped lower element 502 and the concave upper element 501 create a waffle in the shape of a bowl. The bowl-shaped waffle may be used to hold other food items, such as fruit, ice cream, or breakfast foods.

The waffle form 500 has waffle pattern formed into the body of the upper element 501 and the lower element 502 and any other suitable elements, such as a sidewall 505. The waffle pattern may be cast into the body of the elements 501, 502, 505 or stamped into the elements 501, 502, 505. The pattern may be a classic waffle pattern, a honeycomb pattern, or any suitable pattern. When a waffle is cooked, the pattern is imprinted into the waffle.

FIG. 7 is a perspective view of one embodiment of an open waffle form 500. The waffle form 500 has the upper element 501, the lower element 502 and the sidewalls 505. As depicted, the sidewalls 505 are formed as part of the lower element 502. The waffle form 500 is opened via the hinge 503. The upper element 501, the lower element 502 and the sidewalls 505 each are formed or cast with the waffle pattern.

Returning to FIG. 2, in block 120, the user closes the waffle form 500 to create a sealed cooking environment 504 for the ingredients. The user closes the waffle by rotating the upper element 501 on the hinge 503. When the hinge 503 is in a closed position such that upper element 501 and lower element 502 are in contact, a seal is formed around the edge of the upper element 501 and the lower element 502.

The upper element 501 and the lower element 502 may be sealed together by any suitable clasp, latch, lock, hook, or any other type of fastener. The fastener may be placed on the opposing side of the waffle form 500 from the hinge 503. In alternate examples, additional fasteners may be used, such as 2, 3, or 4 fasteners disposed around the seal of the waffle form 500. When sealed, the upper element 501 and the lower element 502 create a cooking environment that holds the ingredients and prevents the ingredients from spilling out of the waffle form 500.

In block 130, the user places the waffle form 500 on a shelf in a multi-purpose cooker 700.

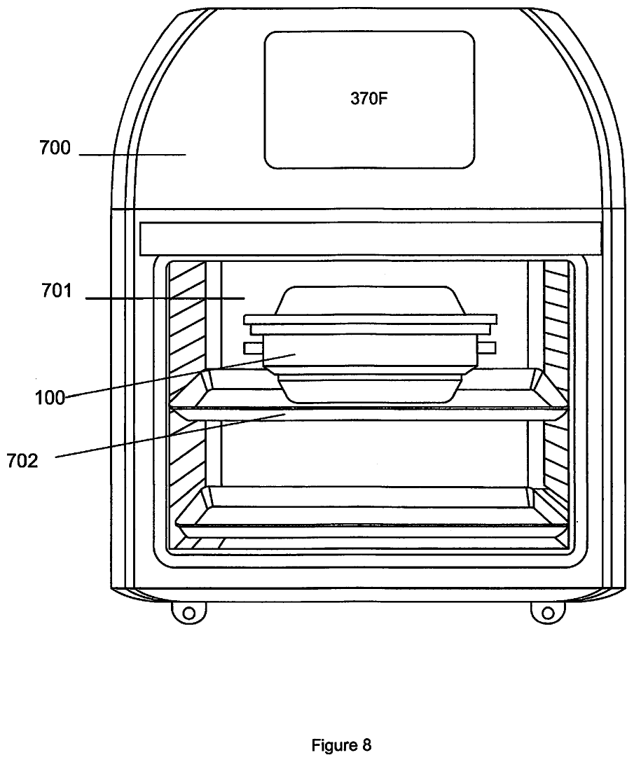

This block 130 is described in greater detail in FIG. 8. FIG. 8 is a side view of one embodiment of a multi-purpose cooker with a waffle form on a shelf.

The multi-purpose cooker 700 may be any suitable kitchen appliance that provides heated circulated air to cook food products, such as an air fryer. The air is circulated at high speeds via fans or other means of force. The multi-purpose cooker 700 may be an air fryer or other type of convection oven that uses heated, high speed air circulation as the cooking mechanism.

In FIG. 8, the multi-purpose cooker 700 is depicted with a shelf 702 disposed in the cooking chamber 701 of the multi-purpose cooker 700. The multi-purpose cooker 700 may be an air fryer or any other type of convection oven or multi-purpose cooker, such as multi-purpose cooker 1100. The shelf 702 is supported on two or three sides by mechanisms in the walls of the multi-purpose cooker 700. The shelf 702 is constructed to support the weight of the waffle form 500 and any enclosed ingredients. In an example, the shelf 702 is constructed of wire, netting, or other similar material that allows the circulated air to pass through the shelf 702. In another example, the shelf 702 is made of a sheet of metal with holes or other openings that allow the circulated air to pass through the shelf 702. The chamber 701 of the multi-purpose cooker 700 contains the heated circulating air for cooking food items in the multi-purpose cooker 700.

As depicted in FIG. 8, the waffle form 500 is placed on the shelf 702. The waffle form 500 is on the shelf 702 inside the chamber 701 of the multi-purpose cooker 700. The heated circulated air passes over and around the surface of the waffle form 500.

Returning to FIG. 2, in block 140, the user initiates the multi-purpose cooker 700 such that heated air is circulated around the waffle form 500. The user may press a button or series of buttons to engage an air fryer function on the multi-purpose cooker 700. The user might perform any other suitable actions to engage the multi-purpose cooker 700. The user may enter a temperature at which to cook the waffle. For example, a cooking temperature of 300 degrees Fahrenheit or greater will cook the waffle at a shorter time than a traditional cooking method.

The multi-purpose cooker 700 engages an air fryer function and heats the air in the chamber 701 to the requested temperature and circulates the air. The air may be circulated by a fan or other mechanism to force the air to circulate around the chamber 701. When performing an air fryer function, the multi-purpose cooker 700 circulates the air at a greater rate than a traditional convection oven or a traditional oven.

The air in the chamber 701 passes over and across the outside surface of the waffle form 500. The air heats the surface of the waffle form 500 as the air contacts the surface. The heat from the air is conducted through the body of the waffle form 500. When the waffle form 500 is constructed of a more heat conductive material, a greater the amount of heat is transferred through the material. The heat that is conducted through the material of the waffle form 500 is transferred to the ingredients inside the cooking environment 504. The heat transferred to the ingredients cooks the ingredients into the waffle or other baked good.

In an example, the material that constructs the waffle form 500 is of a substantially uniform thickness. That is, the upper element 501, the lower element 502, and the sidewalls 505 all are of a uniform thickness. The uniform thickness allows the heat to be transferred from the air to the ingredients in uniform, even speed. The uniform heat transfer allows the waffle form 500 to cook the waffle evenly on all sides at an even rate.

The multi-purpose cooker 700 may have a timer or other means of determining when the cooking of the waffle is complete.

Returning to FIG. 2, in block 150 the user removes the waffle form 500 from the multi-purpose cooker 700 when the waffle is cooked. The multi-purpose cooker 700 may have a timer or other means of determining when the cooking of the waffle is complete.

In block 160, the user removes the waffle from the waffle form 500. The user unclasps the fastener or other mechanism sealing the waffle form 500. The user removes the waffle from the waffle form 500 by any suitable method, such as by inverting the waffle form 500 such that the waffle falls out, or using a utensil to lift and remove the waffle.

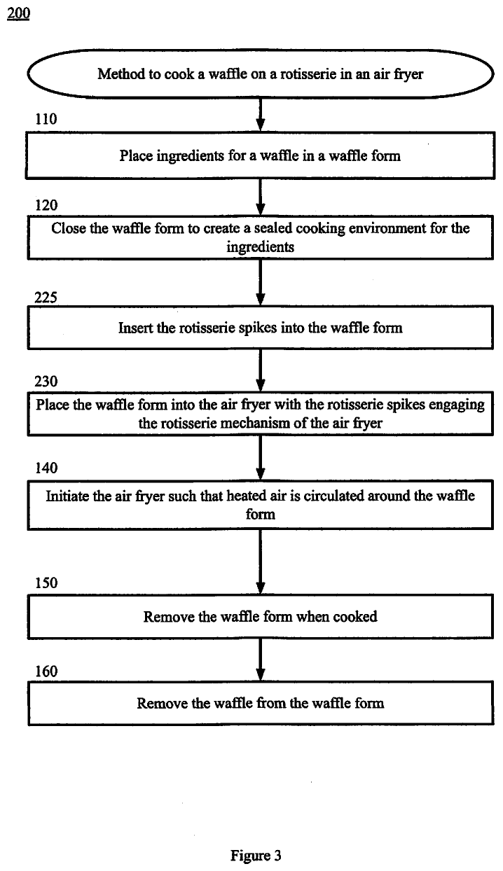

FIG. 3 is a block diagram depicting a method to cook a waffle on a rotisserie in an a multi-purpose cooker 700, in accordance with certain examples of the technology disclosed herein. Blocks 110 and 120 are performed substantially the same as blocks 110 and 120 in FIG. 2.

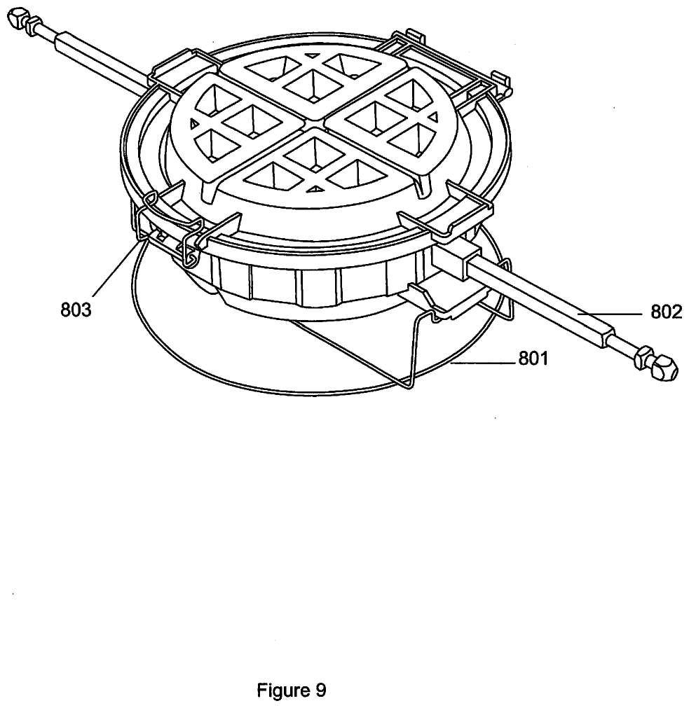

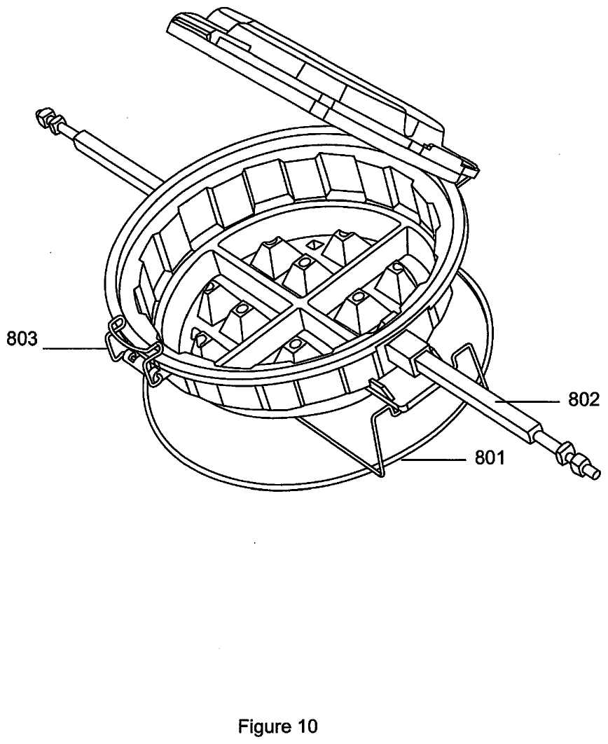

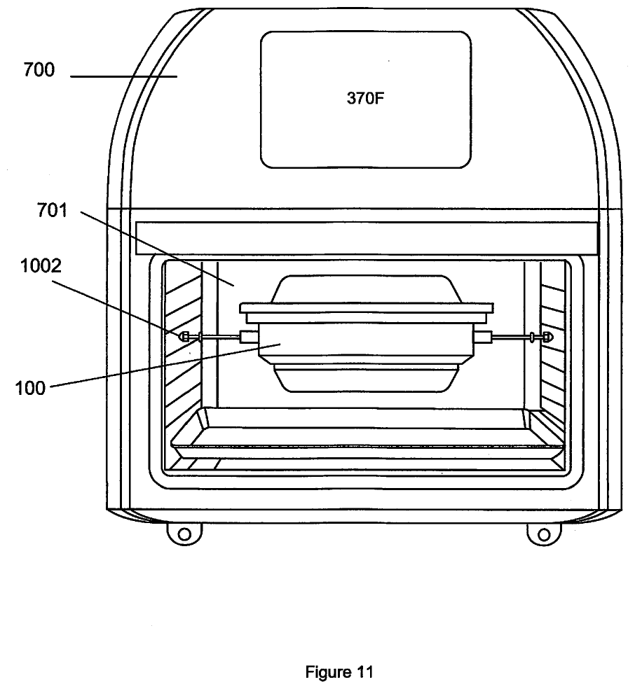

In block 225, the user inserts rotisserie spikes 802 into the waffle form 500. The rotisserie spike 802 may be any suitable mechanism or device to allow the waffle form 500 to be fitted to a rotisserie function of the air fryer 700. For example, instead of rotisserie spikes 802, the multi-purpose cooker 700 may utilize a rotating basket or other suspended and rotating device to spin the waffle form 500. Examples of block 225 are illustrated in FIG. 9, FIG. 10, and FIG. 11.

FIG. 9 is a perspective view of one embodiment of an open waffle form with rotisserie spikes and a stand.

In this example, the rotisserie spikes 802 are inserted into slots or openings in the sidewall 505 of the lower element 502. The rotisserie spikes 802 may lock into place with a locking mechanism or merely be held in by friction. The rotisserie spikes 802 may have any type of end for insertion and locking into a rotisserie mechanism on the multi-purpose cooker 700. In FIG. 9, the end of the rotisserie spikes 802 include a hexagonal nut or other mechanical locking mechanism.

The waffle form 500 is illustrated as sitting on a stand 801. The stand may be used to support the waffle form 500 while inserting the spikes, while the waffle form 500 is hot, or at any other suitable time.

The waffle form 500 is illustrated with a fastener 803 for sealing the cooking environment shut. The fastener 803 is shown as a friction clasp, but any suitable fastener may be utilized to seal the waffle form 500.

FIG. 10 is a perspective view of one embodiment of a multi-purpose air fryer with a waffle form affixed to a rotisserie mechanism. FIG. 10 includes similar elements to FIG. 9, such as the rotisserie spikes 802, the stand 801, and the fastener 803.

Returning to FIG. 3, in block 230, the user places the waffle form 500 into the multi-purpose cooker 700, such as an air fryer, with the rotisserie spikes 802 engaging the rotisserie mechanism 1002 of the multi-purpose cooker 700. The connection between the rotisserie spikes 802 and the rotisserie mechanism 1002 may be any suitable connection. For example, the rotisserie spikes 802 may form a friction connection with the rotisserie mechanism 1002. In another example, the rotisserie spikes 802 may screw into the rotisserie mechanism 1002. The details of block 230 are illustrated in FIG. 11.

FIG. 11 is a perspective view of one embodiment of a multi-purpose cooker 700 with a waffle form 500 affixed to a rotisserie mechanism 1002. The multi-purpose cooker 700 is substantially similar to the multi-purpose cooker described in FIG. 8, a multi-purpose air fryer such as multi-purpose cooker 1100, or any other suitable air fryer. In this example, the waffle form 500 has rotisserie spikes 802 inserted into the rotisserie mechanism 1002 of the multi-purpose cooker 700 such that the waffle form 500 may be spun around an axis. In an example, the waffle form may be spun a rate such as one revolution per minute, two revolutions per minute, or any other suitable rate. The rotisserie mechanism 1002 may be driven by an electric motor of the multi-purpose cooker 700 or any other suitable drive mechanism.

Returning to FIG. 3, blocks 140 to 160 are performed substantially similar to blocks 140 to 160 of FIG. 2.

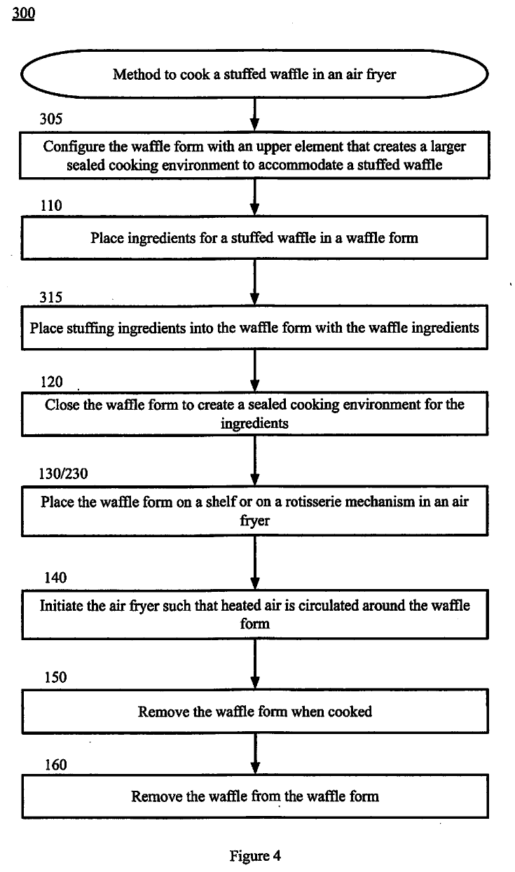

FIG. 4 is a block diagram depicting a method to cook a stuffed waffle in an multi-purpose cooker 700, in accordance with certain examples of the technology disclosed herein.

In block 305, the user configures the waffle form 500 with an upper element 501 that creates a larger sealed cooking environment 504 to accommodate a stuffed waffle. For example, the waffle form 500 may come with interchangeable parts to increase the size/volume of the cooking environment 504. The upper element 501 may have a domed, convex top to create the larger sealed cooking environment 504. In another example, the upper element 501 or the lower element 502 has taller sidewalls 505 to create the larger sealed cooking environment 504. The upper element 501 may be changed by removing the upper element 501 from the hinge and replacing the upper element 501 with an upper element 501 that creates a larger cooking environment 504. Any other changes to the upper element 501 and the lower element 502 may be utilized to create a larger cooking environment 504.

Block 110 is substantially similar to block 110 of FIG. 2.

In block 315, the user places stuffing ingredients into the waffle form 500 with the waffle ingredients. The ingredients placed in the waffle form 500 may include any stuffing ingredients desired. For example, food items such as bacon, sausage, fruit, pie filling, pizza toppings, cream cheese, or any other suitable stuffing, are placed into the waffle form 500 with waffle batter. In an example, waffle batter is placed into the waffle form 500, followed by one or more stuffing ingredients, which are followed by an additional amount of waffle batter such that the stuffing ingredients are enclosed within the waffle batter.

Block 120 is substantially similar to block 120 of FIG. 2. Block 130/230 is substantially similar to block 130 of FIG. 2 or block 230 of FIG. 3, depending on whether the user desires to place the waffle form 500 on a shelf 702 or to utilize the rotisserie mechanism 1002.

Blocks 140 to 160 are substantially similar to blocks 140 to 160 of FIG. 2.

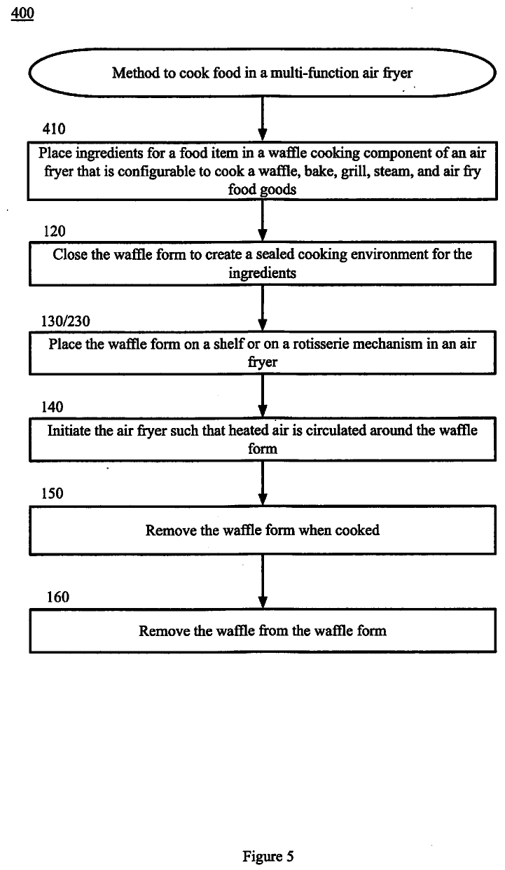

FIG. 5 is a block diagram depicting a method to cook food in a multi-function cooker, such as multi-purpose cooker 1100 described in FIG. 1, in accordance with certain examples of the technology disclosed herein.

In block 410, the user places ingredients for a food item in a waffle cooking component of a multi-purpose cooker 1100 that is configurable to cook a waffle, bake, grill, steam, and air fry food goods.

The multi-purpose cooker 1100 is suitable to cook various foods in different configurations and also air fry foods. The multi-purpose cooker 1100 utilizes one or more of a set of components to cook the waffle. The component to cook the waffle may be the waffle form 500 as described herein. The component to cook waffles may also be utilized as described herein to cook a stuffed waffle or other baked stuffed good. The multi-purpose cooker 1100 includes other components that are configured to grill, air fry, steam, and bake food products. The multi-purpose cooker 1100 may use a grill component, such as a plate with or without raised grilled cross hatching, that is heated to grill meat, vegetables, or other food products. The plate is heated in the chamber 1101 via the heated circulated air. Another component may be a wire basket or wire bowl for air frying food products. Another component of the multi-purpose cooker 1100 provides steam to a container inside the chamber to steam food products.

Block 120 is performed substantially the same as block 120 in FIG. 2.

Block 130/230 is substantially similar to block 130 of FIG. 2 or block 230 of FIG. 3, depending on whether the user desires to place the waffle form 500 on a shelf or to utilize a rotisserie mechanism.

Blocks 140 to 160 are substantially similar to blocks 140 to 160 of FIG. 2.

What is claimed is:

1. A method to cook a waffle, comprising:
placing ingredients in a waffle form to create a sealed cooking environment, the waffle form being constructed of heat conductive metal that is a uniform thickness across an upper element and a lower element of the waffle form; and
placing the waffle form in a chamber of circulating heated air, wherein the waffle form receives heat from the circulating heated air across surfaces of the waffle form and conducts the heat to the ingredients.

2. The method of claim 1, further comprising placing the waffle form on a shelf inside the chamber.

3. The method of claim 1, further comprising:
affixing rods to the waffle form; and
connecting the affixed rods to a rotisserie mechanism inside the chamber.

4. The method of claim 1, further comprising adjusting the temperature of the chamber such that the heated circulated air is in excess of 300 degrees Fahrenheit.

5. (canceled)

6. The method of claim 1, wherein the waffle form comprises a surface configured to create a waffle pattern in a top and a bottom surface of the ingredients when cooked.

7. The method of claim 1, wherein the waffle form is heated only from the circulated heated air of the chamber.

8.-30. (canceled)

31. The method of claim 1, wherein the waffle form upper element has an upward convex shape.

32. The method of claim 31, wherein the convex shape of the upper element creates a sealed cooking environment that is larger than a sealed cooking environment created by a flat upper element, the created sealed cooking environment being of a size that will encompass a waffle and at least one stuffing ingredient.

33. The method of claim 1, wherein the lower element has a convex downward bowl shape to create a sealed cooking environment that is shaped to create a waffle in a shape of a bowl.

34. The method of claim 1, wherein the chamber of circulating heated air is created by an air fryer.

35. The method of claim 1, further comprising, after removing the waffle form from the chamber of circulating heated air, placing food products in the chamber of circulating heated air to air fry the food products.

36. The method of claim 1, further comprising, after removing the waffle form from the chamber of circulating heated air, placing food products on a grill component inside the chamber of circulating heated air to grill the food products.

37. The method of claim 1, further comprising, after removing the waffle form from the chamber of circulating heated air, placing food products in a form in the chamber of circulating heated air to cook a stuffed baked good.
